(19) United States
(12) Patent Application Publication
(10) Pub. No.: US 2004/0067352 A1
(43) Pub. Date: Apr. 8, 2004

(54) Rigid composite building materials and assemblies utilizing porous and non-porous rigid foamed core materials

(76) Inventors: Joseph W. Hagerman, Starkville, MS (US); Jason Derbort, Madison, AL (US); William G. Ramsey, Starkville, MS (US); Brian M. Kauffman, Starkville, MS (US); Adriana Giordana, Mississippi State, MS (US); Daye Dearing, Starkville, MS (US)

Correspondence Address: Supervisor, Patent Prosecution Services, PIPER RUDNICK LLP, 1200 Nineteenth Street, N.W., Washington, DC, 20036-2412, US

(21) Appl. No.: 10/263,779

(22) Filed: Oct. 4, 2002

(51) Int. Cl. B32B 3/26

(52) U.S. Cl. 428/304.4

(57) ABSTRACT

A composite structure suitable for use used for structural applications, as well as for sheathing and finishes, and packaging and crating materials, comprising layers of foamed core material, alternating with layers of material designed to absorb shear stresses, such as rigid structural membrane, and one or more external protective layers, thereby preventing damage to the foamed core material and increasing the strength and integrity of the overall assembly. The resulting structure is a panel resistant to shear, tension, and impact forces, as well as having resistance to vermin, fire, and aging. In some variations, the assembly comprises materials that are environmentally safe to produce and to dispose. The properties of the panels, including, for example, permeability, organic composition, absorption, and strength are tailorable to specific applications by using appropriate foamed material and protective layers.

### BACKGROUND OF THE INVENTION

1. Field of the Invention

The present invention relates to the field of building materials, and in particular to multi-layer panels and assemblies, used as either structural or nonstructural panels, platforms, sheathing, or insulation.

2. Background of the Technology

Sandwich panels comprising layers of plastic foam materials for insulation purposes have been used in the building industry for over a decade. Depending on the panel structure, the sandwich panels have been used as structural elements or for exterior sheathing. These panels are light and relatively inexpensive, can be prefabricated, and allow for rapid assembly at the construction site. However, the plastic and hydrocarbon based foam typically used in prior art panels has been known to deteriorate due to environmental factors, does not withstand impact well, can be easily penetrated by insects, rodents, and moisture, is flammable, and produces toxic fumes when burning. Additionally, the manufacturing process of the foam and the disposal of its residue can be environmentally damaging and costly. Thus, a replacement for plastic and hydrocarbon based foam material is needed.

Before being declared acceptable for construction, materials must be evaluated for compressive strength (failure by crushing and bending stress), tensile strength (failure by pulling apart, bending stress, and bending failure), shear strength (vertical shear stress failure and bearing stress failure), and surface deformation (deflections). These tests measure the ability of a material to withstand external forces, such as shear forces. These external forces cause internal failures within materials that may lead to deterioration or destruction of the material, or severely limit the performance of the assembly. The effects of external forces on slabs of materials are illustrated in FIG. 1.

FIG. 2 shows the different behaviors of rigid and non-rigid structures under loading. Rigid foamed materials, such as foamed glass, foamed silicate, or fly ash, are not flammable, and are resistant to moisture, vermin, and fire. Thus, these materials are desirable for building applications, for example; however, such materials, when used independently, may not perform well under shear and tensile stress (see, for example, description below regarding non-rigid structures).

The table shown in FIG. 3 compares some physical properties of rigid foamed cellular material (including, but not limited to, foamed glass and foamed fly ash) to traditional polyurethane and polystyrene plastic material, including but not limited to Expanded Polystyrene (EPS and XPS) foam.

Rigid foamed materials do not have high modulus of elasticity with respect to other building materials. Therefore, traditionally the use of rigid foamed materials for building products has been severely limited. FIG. 4 presents a graphical representation of modulus of elasticity versus material type, for selected materials. As shown in FIG. 4, glassy or lattice structured foamed materials (including but not limited to foam glass) have a significantly lower modulus of elasticity—thus a higher resistance to being elastic—than other materials.

When structurally tested, rigid foamed materials fail in shear, tension, and elasticity as the cells deflect when loaded to the point of catastrophic failure of the material. This is due to the low modulus of elasticity of these materials, compared to other cellular materials. Thus, rigid foamed materials, such as foam glass, fail in response to shear and tensile forces prior to traditional cellular materials. The low modulus of elasticity and the low tensile strength of rigid cellular material prevent this material from being used as a feasible building material because, when used alone, it is too weak to be shipped and used on job sites (it is very prone to shear and tensile cracking). Additionally, for these reasons, assemblies using rigid foamed material are severely limited if the material is treated in the same manner as other, more common, cellular materials.

FIGS. 5 and 6 demonstrate typical failure of existing rigid foamed materials. FIG. 5 shows deformation of traditional cellular materials (expanded polystyrene foam). FIG. 6 shows deformation of traditional foam glass.

FIG. 7 presents a representative diagram of simple loading of an unfixed beam, and FIG. 8 shows the corresponding resultant deflection diagram.

FIG. 9 is a diagram of simple loading of a fixed beam on both edges. Failure will occur at point in the material where internal stresses shift across the assembly, causing the material to shear—because a material cannot deflect over the entire length of the assembly when fixed, rigid foamed material will fail in shear, or to tensile forces, as shown in FIG. 10.

However, despite stress failure concerns, the resistance to fire, vermin, aging, infiltration, and environmental factors make the use of rigid foamed materials highly desirable in building applications. Furthermore, the higher projectile and blast-resistance of these materials make them suitable for certain applications where other foamed materials are unsuitable, such as high strength shelters able to withstand tremendous impact and high temperature.

3. Related Art

Sandwich panels comprising layers of plastic foam materials for insulation purposes have been used in the building industry for over a decade. Such panels are described, for example, in patent U.S. Pat. No. 4,269,006 to Larrow.

In an attempt to take advantage of the desirable properties of rigid foamed materials, panels have been formed that incorporate materials such as foam glass with other materials, attempting to obviate its disadvantages. Such panels are disclosed, for example, in patents U.S. Pat. No. 5,516,351 to Solomon et al., French Patent No. 2,746,829, U.S. Pat. No. 5,309,690 to Symons, and U.S. Pat. No. 5,187,913 to Lereau. None of these disclosed panels have high shear or impact resistance, as they do not address the detrimental effect of these forces acting on the foamed material.

U.K. Patent No. 543,882 and U.S. Pat. No. 4,798,758 to Nagano et al., show incorporation of wire netting into foam glass during the process of foaming the material. This netting improves the impact resistance of the panel, but does nothing to prevent disintegration of the foam glass under shear forces (specifically on surfaces of the foamed material).

U.S. Pat. No. 5,834,082 to Day, which is aimed mainly at vehicle applications, discloses a sandwich structure of complex fabrication cut at an angle to produce a layer that withstands vibrations, but would break apart under severe impact. The '082 patent discloses several structures stacked made up of strips or inclined and complexly constructed stacks of adhered materials, which are then formed into the boards having a porous web composition. The disclosed inclined and other complex material structures result in more flexibility than would be desirable for a panel used in many applications, such as a fixed building. The angle or other complex structure is required to increase the area of the bond between the layers, or the structure would delaminate upon impact. The invention aims mainly toward application in vehicles such as boats, trucks and trailers that have requirements different from many other applications, such as fixed buildings, which generally require more rigid structural properties. Further, the panel fabrication of the '082 patent is very complex, and the boards are not sufficiently impact resistant for many applications.

Additional background information regarding construction materials and techniques is provided in Schodek, Daniel, Structures, (Prentice-Hall) 1992, which is hereby incorporated by reference.

Thus, there remains an unmet need for a construction panel that incorporates the desirable properties of rigid foamed materials, with the impact resistance and capability of withstanding interior shear and tensile stress that exist in other materials.

### SUMMARY OF THE INVENTION

The present invention relates to composite building materials having a main core that is made from a porous or non-porous rigid foamed core material (including, but not limited to, foamed glass, foamed fly-ash, foamed silicate, and other foamed materials). These foamed materials are highly desirable because of their low cost (as compared to petroleum based foamed material), resistance to vermin, fire, moisture, temperature degradation, and environmental benefit (as they can be made from recycled or waste materials). Also, their impact resistance makes them more resistant to projectiles and explosions than those constructed, for example, using petroleum-based materials.

Some foamed materials have different structural abilities and properties than other cellular materials typically used in building products, such as a lower modulus of elasticity (less than, but not limited to 1.0 gigapascals). Consequently, additional methods of construction must be used in order to include porous and non-porous rigid foamed material in building applications and assemblies. These additional methods include adding features or constructing techniques that reduce or remove the interior shear and tension forces acting on the core and protect the surface from deformation, thereby strengthening the entire assembly.

An embodiment of the present invention is a structure comprising layers of foamed core material, alternating with layers of material designed to absorb the shear stresses that may damage the foamed core material and to increase the strength and integrity of the entire assembly. The result is a panel, as compared to prior art, that has a higher resistance to shear, tension, and impact forces, as well as resistance to vermin, fire, and aging. Additional properties of the panels (including, but not limited to, permeability, organic composition, absorption, and strength) can be tailored to specific applications by using appropriate foamed material and protective layers. The panels can be used for structural applications, as well as for sheathing and finishes. Panels may also be used for packaging and crating materials.

The assemblies of the present invention are superior to standard (including, but not limited to, cellular core material) construction products because they can be pre-cut at fabrication, providing easy assembly of, for example, a building. In addition, they provide excellent thermal insulation and vermin resistance, and outperform more common, more environmentally unstable—as well as more expensive—cellular based assemblies.

To meet these property requirements and to provide other features, the present invention is directed toward a composite panel or assembly, structurally superior to traditional cellular material building products. The disclosed panels include at least one rigid foamed core and at least one chemically or mechanically attached membrane (arranged or unarranged) capable of absorbing shear and tension stresses acting on the assembly, thus greatly mitigating the internal stresses experienced by the foamed core and preventing its deterioration or failure. The panels also optionally include outside facing, protective layers, or other external covering known in the art, which is varied to adapt the panel to a specific application (structural wall member, exterior sheathing, flooring, roofing, etc.).

Disclosed below are arrangements of these layers, which allow the assemblies to perform superiorly to traditional cellular building materials as:

a. assemblies that have enhanced structural performance (e.g., membranes act as added structural layers allowing assemblies to outperform the prior art)

b. assemblies that are resistant to penetration forces (e.g., membranes act as webbing or protective shells to stop or minimize penetration)

c. assemblies that have adjustable cellular size and permeability of the entire assembly or within the assembly (e.g., differing layers of cellular materials can allow for different permeability), and

d. assemblies and membranes that are resistant to fire, mold, and infiltration damage (e.g., membranes and cellular materials are be used in combination to minimize, resist, and mitigate fire, mold, and infiltration damage).

The assemblies disclosed herein can be inexpensively and easily fabricated to specified dimensions. The cost can be further reduced if recycled material, such as waste material, is incorporated in the foamed layer (including, but not limited to, waste glass in foam glass or fly ash in foamed fly ash).

These rigid foamed core materials can be used as building or packaging products that include, but are not limited to, structural panels, structural insulated panels, exterior and interior sheathing, backing board, floor and ceiling tile, floor, wall, and roof assemblies, exterior and interior tile, structural insulation (for use in, but not limited to, appliances), exterior insulation and finishing systems, as a replacement for rigid or blown insulation products, countertops and other laminates, structural members (including, but not limited to, boards, and dimensional lumber type members), and low density structural materials (including, but not limited to, rigid floatable assemblies).

Alternatively, the assemblies of the invention can be used in the formation of fire, blast, and projectile resistant enclosures or partitions (such as safes, refrigerated compartments, ovens, severe weather shelters, etc.) capable of withstanding severe and sudden impacts or external stresses.

Furthermore, the assemblies can be formed to include breathable materials, such as open glass foams or moisture-impervious material such as closed-cell foams. An increase in R-value and reduction in weight can be achieved by using materials with larger foam cells. Selecting among these different foams, or including several foamed layers with different properties within the same panel, allows the variable formation of fire, stress, and impact-resistant insulated panels, with properties tailored to specific applications.

Further, the panels of the invention outperform traditional panels comprising petroleum based cellular materials, in structural tests.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

FIG. 1 shows the effect of external forces on materials in different loading conditions;

FIG. 2 shows the effect of loading on rigid and non-rigid structures;

FIG. 3 contains a table of physical properties comparing rigid cellular foamed material to traditional cellular materials;

FIG. 4 compares the modulus of elasticity of a number of materials commonly used in the construction industry;

FIGS. 5 and 6 present photographs comparing how polystyrene foam and foam glass react to applied pressure;

FIG. 7 presents a representative diagram of simple loading of an unfixed beam;

FIG. 8 shows the corresponding resultant deflection diagram for the unfixed beam of FIG. 7;

FIGS. 9 and 10 are diagram of simple loading of a fixed beam on both edges;

FIGS. 11 and 12 illustrate how a conventional polystyrene foam panel breaks upon severe structural loading;

FIGS. 13 and 14 show how a panel formed in accordance with embodiments of the present invention maintains substantial structural integrity upon severe structural loading;

FIG. 15 shows a composite structure formed in accordance with a first embodiment of the present invention;

FIG. 16 is a composite structure formed in accordance with a second embodiment of the present invention;

FIG. 17 illustrates a composite structure formed in accordance with a third embodiment of the present invention;

FIG. 18 presents a composite structure formed in accordance with a fourth embodiment of the present invention;

FIG. 19 shows a composite structure formed in accordance with a fifth embodiment of the present invention;

FIG. 20 is a composite structure formed in accordance with a sixth embodiment of the present invention;

FIG. 21 illustrates a composite structure formed in accordance with a seventh embodiment of the present invention;

FIG. 22 presents a composite structure formed in accordance with a eighth embodiment of the present invention;

FIG. 23 is a composite structure formed in accordance with a ninth embodiment of the present invention;

FIG. 24 shows an example of a larger single-core panel constructed by stacking rigid foam core material components (in a brick like, alternating course fashion) and protective layers having smaller dimensions, in accordance with an embodiment of the present invention;

FIG. 25 shows an example of a larger multiple-core panel constructed by stacking rigid foam material components (in a brick like, alternating course fashion) and protective layers having smaller dimensions, in accordance with an embodiment of the present invention;

FIG. 26 shows the wrapping of the structural reinforcing membrane around the panel edge for a single-core panel, in accordance with an embodiment of the present invention;

FIG. 27 shows the wrapping of the structural reinforcing membrane around the panel edge for a multiple-core panel, in accordance with an embodiment of the present invention;

FIG. 28 shows the wrapping of the structural reinforcing membrane around the panel edge cut to dimension, in accordance with an embodiment of the present invention; and

FIG. 29 shows the embedding of material (structural and non structural members) other than rigid foam within the panel, in accordance with an embodiment of the present invention.

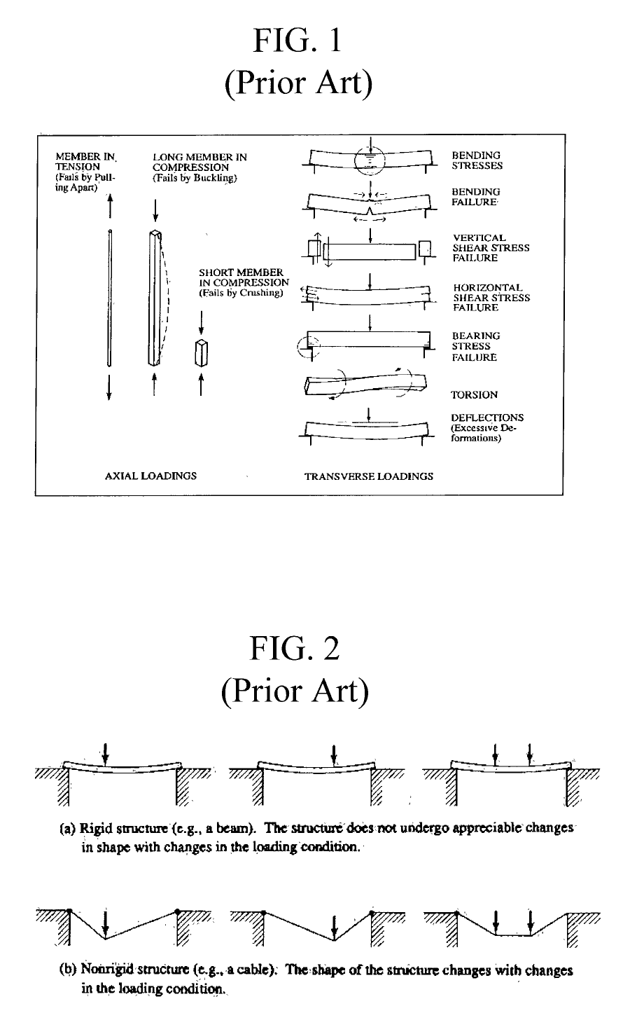

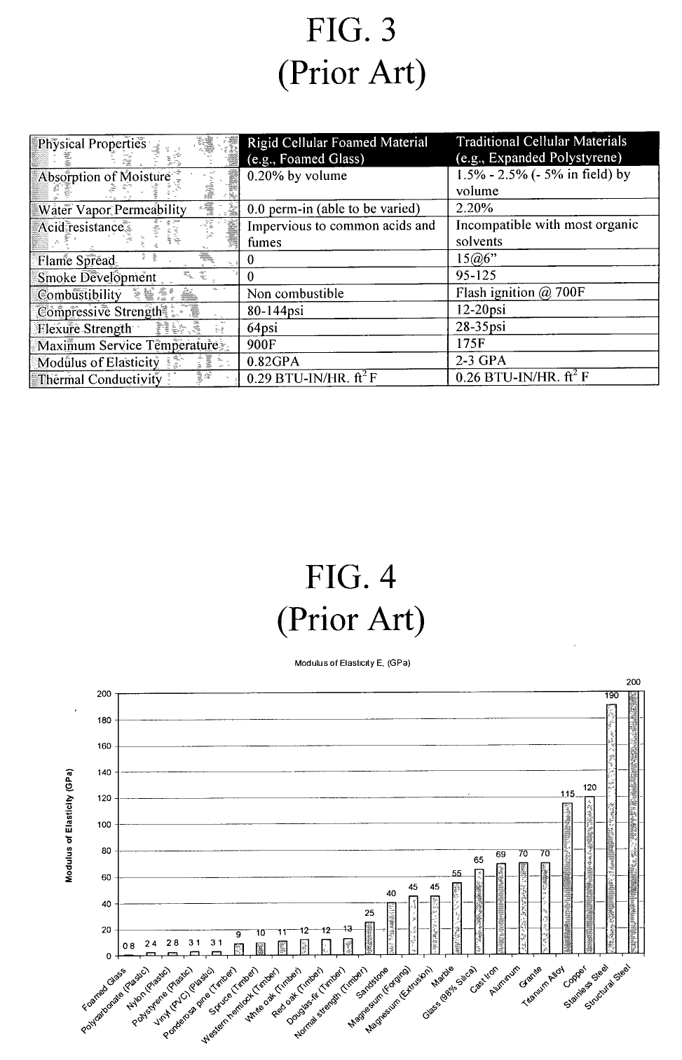

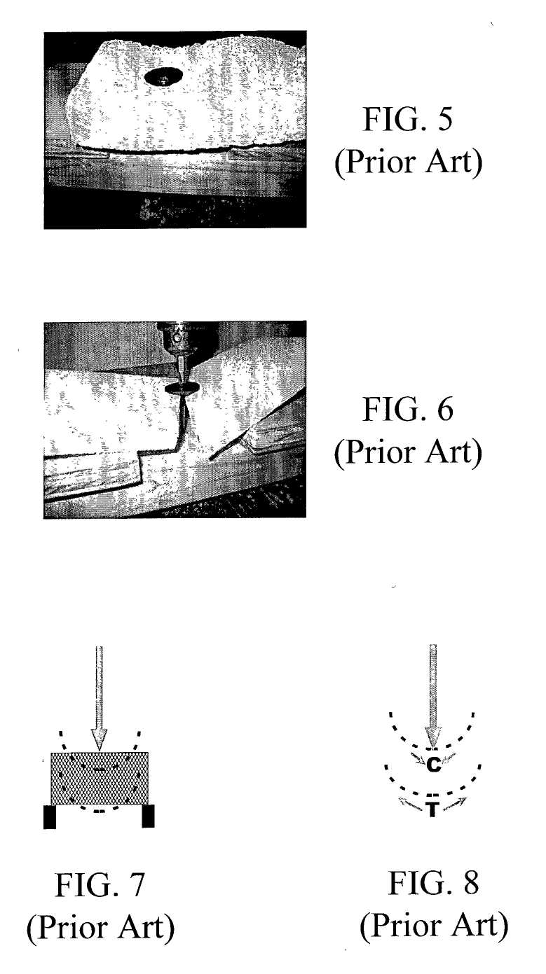

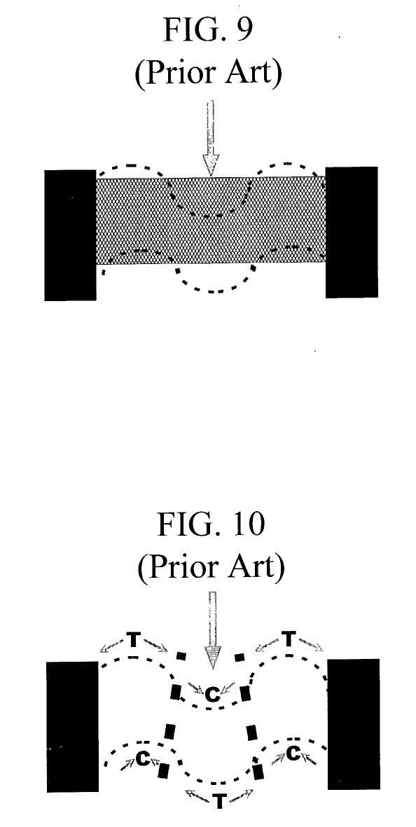

### DETAILED DESCRIPTION OF THE INVENTION

The present invention relates to composite structures, such as panels, composed of layers of materials, including rigid foamed core material, reinforcing structural membrane, and protective layers.

The panels of the present invention are usable as replacement for exterior materials of the prior art, such as exterior insulation and finish systems (EIFS), in comparison with which, the panels of the present invention have all of the advantages, without the disadvantages, as the present invention panels are impact and humidity resistant and less expensive to produce.

The panels of the present invention are also usable as alternatives to standard construction techniques, allowing formation of exterior or interior walls, roofs, or floors that are vermin and fire-resistant, thermally insulating, and inexpensive.

In general, the panels of some embodiments of the present invention, which include foam glass portions, are superior to panels comprising low modulus of elasticity cellular materials (e.g., Styrofoam®, made by The Dow Chemical Company of Midland, Mich.; expanded polystyrene), in that the panels of the present invention are impervious to termites, mice, and other vermin, do not deteriorate when exposed to humidity, are impact resistant, are not flammable, and do not produce toxic fumes when exposed to high temperatures. Also, the cost of the foam glass panels of the present invention is less than materials of the prior art, and the foam glass components of the present invention are ecologically friendly, as these materials are able to incorporate waste glass material.

The panels of the present invention are superior to foam glass panels of the prior art in that, for example, the present invention panels are resistant to stress and shear forces, as well as to impact. The netting or other reinforcing structural material positioned between the foam glass layer and the outside facing, or between layers of foam glass, in embodiments of the present invention, acts as a buffer and prevents shear forces from cracking or deteriorating the foam glass.

The results of large shear forces are therefore reduced by the present invention features of alternating layers of foam glass and reinforcing structural material. Since this reinforcing structural material is exterior to the foam glass and is able to provide stress relief, this structure is not equivalent to, for example, netting incorporated into the foam glass slab.

The panels of the present invention are formable so as to adapt to the weight and insulation requirements of a particular application by varying the size of the cells in the foam glass and the thickness of the foam glass panel. Furthermore, the use in embodiments of the present invention of open-cell or closed-cell material affects the properties of the panel with respect to moisture. For example, open-cell foam glass is able to absorb and release moisture and is usable in cases in which a “breathable” material is preferred. Closed-cell foam glass is selected, for example, when a layer impervious to moisture is preferred.

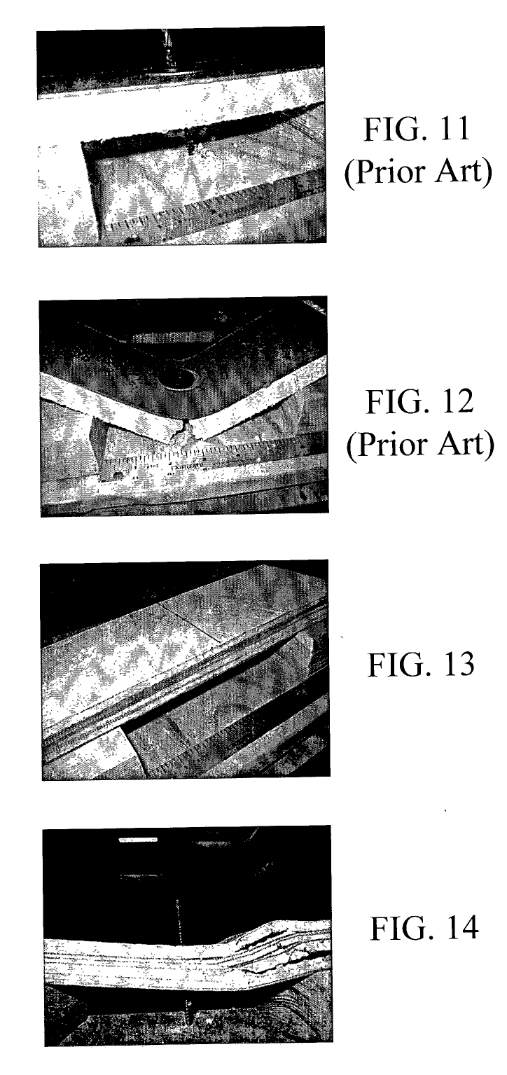

Further, the panels of the invention outperform traditional panels comprising petroleum based cellular materials, in structural tests. FIGS. 11-14 compare the behavior of a traditional polystyrene panel and a panel of comparable thickness, fabricated according to the invention, when undergoing structural loading until complete failure. The traditional panel failed completely, while the panel of the invention, although deformed, conserves substantial structural integrity.

FIGS. 11 and 12 present traditional polystyrene of the prior art used as a panel, before and after structural loading until complete failure.

FIGS. 13 and 14 show a rigid foamed core assembly used as a panel, in accordance with the present invention, before and after structural loading until failure.

Thus, the panels of embodiments of the present invention are adaptable to accommodate a variety of requirements, in contrast with the panels of the prior art.

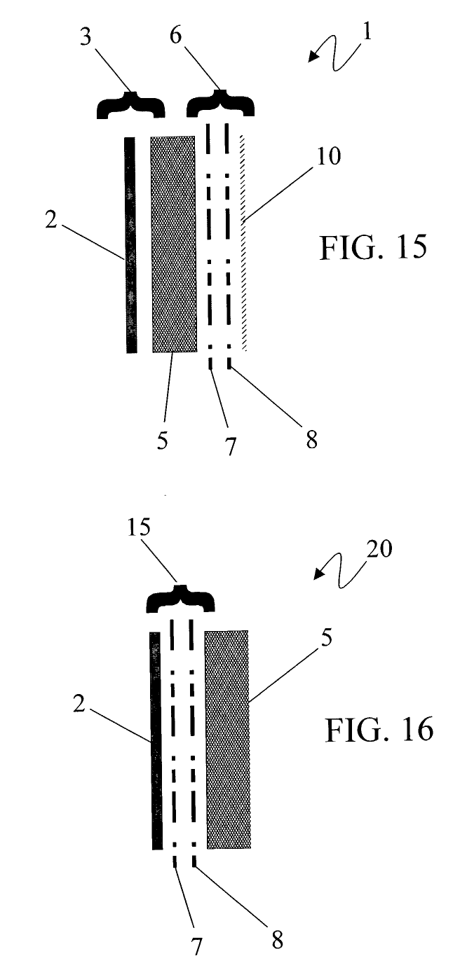

Depicted in FIG. 15 is a composite foamed core rigid insulated board 1, also referred to interchangeably herein as a composite structure, utilizing foamed core materials, in accordance with a first embodiment of the present invention. In this embodiment, the composite structure 1 is comprised of an exterior protective layer 2 that is chemically or mechanically attached or adhered 3 to a rigid foamed core material 5. Chemically or mechanically attached or adhered 6 to the back of the rigid foamed core 5 are one or more reinforcing and protective membranes 7, 8, including but not limited to netting, webbing, mesh, and membranes made of inorganic matter (e.g., metals, plastics, glasses) and organic mater (e.g., paper, wood, etc.) that mitigate shear and tension stresses on the composite assembly. As required, a marginal backing piece 10, differing for example from the exterior protective layer 2, is chemically or mechanically attached 6 to the composite assembly.

In embodiments of the present invention, the membranes 7, 8, as well as other components of the structure 1, depending on the composition and characteristics of construction of these components, affect the characteristics of the overall structure 1. For example, more rigid protective membranes 7, 8 increase the structural strength of the structure 1, when for example, the structure 1 is used to support weight. A fine mesh structure for one of the membranes 7, 8, enhances the blast resistance of the structure 1.

Thus, the disclosed assembly performs significantly better than other rigid insulated boards comprised of cellular materials, at least because the added membranes and layers allow the assembly to perform and withstand forces, stresses, and strains that would otherwise cause the core material to fail (primarily as a result of, but not limited to, its low modulus of elasticity). The assembly may have a higher resistance to external forces, including compressive strength (failure by crushing and bending stress), tensile strength (failure by pulling apart, bending stress, and bending failure), shear strength (vertical shear stress failure and bearing stress failure), and surface deformation (deflections), as compared to prior art. These external forces cause internal forces, which, within prior art materials, have led to deterioration and destruction of the material, or have severely limited the performance of assemblies.

In contrast, the rigid foamed core material 5 of the present invention acts to withstand the compression forces within the assembly and allows for the membranes 7, 8 and protective layers 2, 10 to mitigate and withstand the shear, tension, and abrasive forces on the entire assembly. Additionally, the core materials 5, depending on composition, are able to provide a high thermal resistance, enhanced structural performance, increased resistance to penetration forces, a mechanism for providing an adjustable cellular size and permeability of the entire assembly or within the assembly, and a mechanism for increasing in the assembly's resistance to fire, mold, and infiltration damage.

FIG. 16 shows a second embodiment of a composite structure 20 formed in accordance with a second embodiment of the present invention, in which the one or more reinforcing and protective membranes 7, 8 are sandwichably attached 15 between the protective layer 2 and the rigid foamed core material 5. No second protective layer is used as a backing in this embodiment.

In another example of an assembly 30 in accordance with a third embodiment of the present invention, as shown in FIG. 17, a protective layer 2, such as a layer of polyurethane or latex, is attached 35, such as chemically or mechanically (e.g., via nails, screws, or other mechanical attachment mechanisms), to a rigid foamed core material 5, such as, for example, foamed glass. Also attached 35, 36 (e.g., with polyurethane glue) to the rigid foamed core material 15 are reinforcing and protective membranes 7, 8, such as a fiberglass screen, and as needed, a layer of ballistic nylon mesh. Also, as needed, another protective layer layer 10, differing from the protective layer 2, such as a layer of polyurethane film, is attached 36 to the rigid foamed core material 5 via a membrane 8. The assembly 30 of this embodiment optionally is, but is not limited to being, attached or glued and is used as building insulation or exterior siding that is insulated, or is utilized in other building applications.

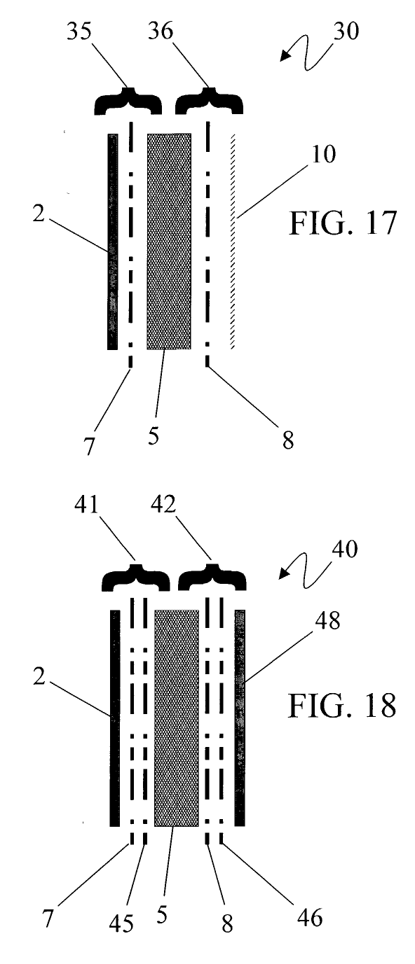

FIG. 18 presents a composite structure formed in accordance with a fourth embodiment of the present invention. As shown in FIG. 18, similar to the third embodiment of FIG. 17, the structure 40 includes a first protective layer 2 attached 41 to a rigid foamed core material 5. Also attached 41, 42 to the rigid foamed core material 15 are reinforcing and protective membranes 7, 8, 45, 46. As needed, a second protective layer 48 is attached 42 to the rigid foamed core material 5 via a membranes 8, 46. In the embodiment shown in FIG. 18, the second protective layer 48 is of the same or a similar type to the first protective layer 2.

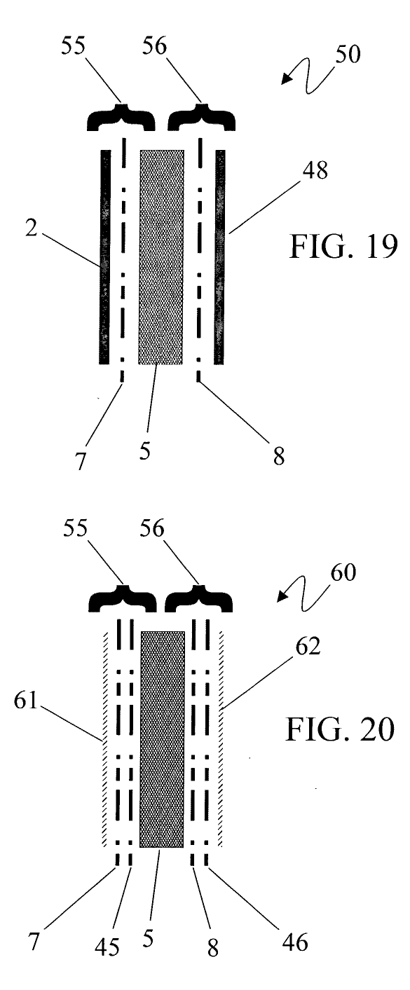

FIGS. 19 and 20 show composite structures formed in accordance with fifth and sixth embodiments of the present invention, respetively. In the exemplary embodiments shown in FIGS. 19 and 20, the structures 50, 60 each include at least one protective layer 2 (FIG. 19) or 61 (FIG. 20) attached 55, such as by chemical or mechanical attachment, either to one structural reinforcing membrane 7, as shown in FIG. 19, or more than one structural reinforcing membrane 7, 45, as shown in FIG. 20. At least one rigid foamed core material 5 is attached 56 to one structural reinforcing membrane 8, as shown in FIG. 19, or more than one structural reinforcing membrane 8, 46, as shown in FIG. 20. At least one protective additional layer 48 (FIG. 19) or 62 (FIG. 20) is also attached 56 to the rigid foamed core material 5.

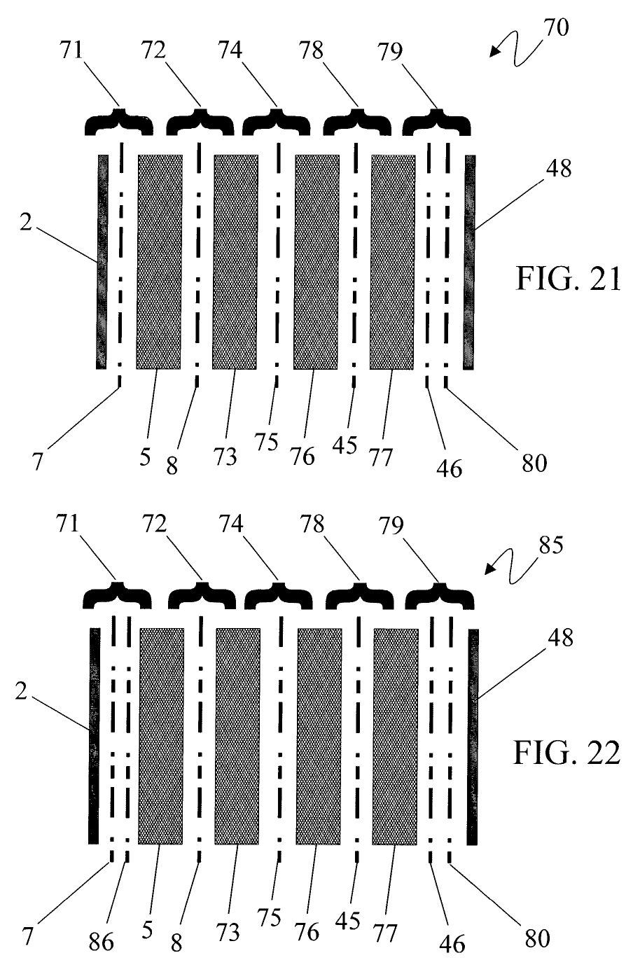

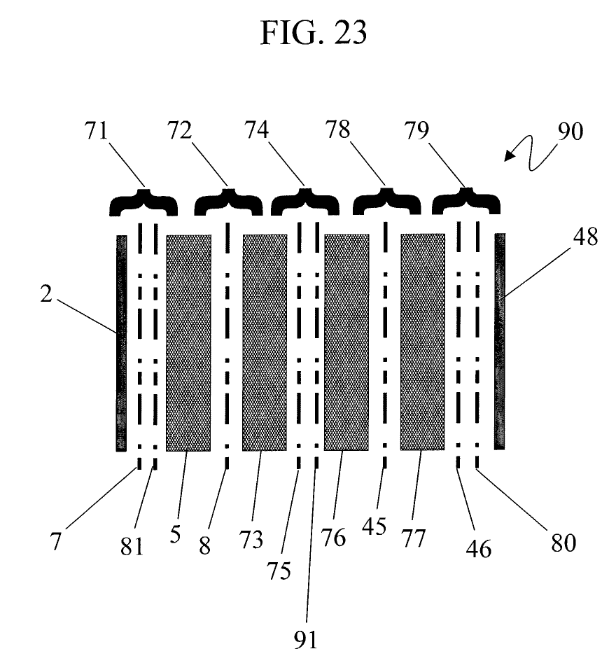

An composite structural assembly in accordance with seventh, eighth, and ninth embodiments of the present invention is depicted in FIGS. 21-23. In these embodiments of composite structures 70, 85, 90, at least one protective layer 2 is attached 71, such as chemically or mechanically attached to one structural reinforcing membrane 7 (FIG. 21) or more than one structural reinforcing membrane 7, 86 (FIGS. 22, 23), which in turn are attached 71 to at least one rigid foamed core material 5. The rigid foamed core material 5 is attached 72 to at least one structural reinforcing membrane 8.

The structural reinforcing membrane 8 is also attached 72 to at least a second rigid foamed core material 73. The second rigid foamed core material 73, in turn, is attached 74 to one structural reinforcing membrane 75 (FIGS. 21, 22) or more than one structural reinforcing membrane 75, 91 (FIG. 23). Alternating additional layers of a rigid foamed core material 76, 77 are attached 78, 79 to structural reinforcing membranes 45, 46, 80 and at least one other protective layer 48.

In all of these variations, layers can be combined, multiplied, and even removed to change the performance of the assembly/structure. Additionally, the properties of each layer and chemical or mechanical adhesion can be modified between layers to enhance the performance of the overall assembly, including material changes which could make the entire assembly vermin resistant, water resistant, and chemically inert and fire “retardant.” The use of different types of rigid foam materials such as foam glass, foam glass formed with waste glass, foamed fly ash, foamed silicate, etc., with an open-cell or closed-cell form, allow tailoring of the properties of the panel (e.g., vapor permeability, weight, or R-value) to the specific requirements of the application.

A specific example of a tailored panel, in accordance with an embodiment of the present invention, could be, for example, a panel with an interior core comprising of at least one layer of closed-cell rigid foam material sandwiched between at least one layer of open-cell rigid foam material. The rigid foam core material structure is sandwiched between protective layers. Each layer of the assembly is separated from the next with at least one structural reinforcing membrane in a manner similar to that illustrated in FIG. 22. To keep the panel intact, each layer is fastened to the next using chemical or mechanical means as discussed above. In this example, the open-cell layers are able to wick moisture away from the protective layer, thus preventing deterioration of the protective layer due to moisture build-up. The closed-cell layer acts as a barrier, preventing moisture propagation from one side of the panel to the opposite side.

The structure can be built with only one layer of open-cell material if moisture transmission through the assembly is desired.

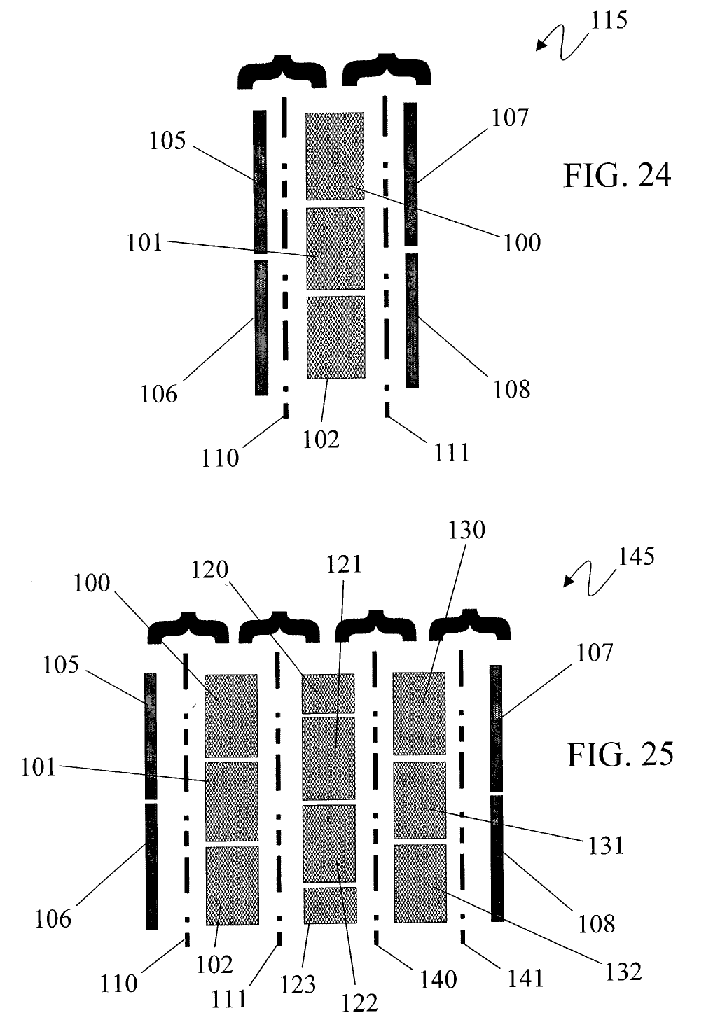

It is noted that the single layer and the multilayer panels taught in this disclosure can be assembled to any desired size, without loss of insulating value, such as can occur at the junction or thermal bridge of the foamed panels described in the prior art. This flexibility in size can be achieved by stacking in a brick-like fashion (alternating the joints of the materials) the multiple pieces of rigid foamed material having each a size smaller than that of the finished panel, as shown in FIG. 24 and FIG. 25. This eliminates the production of a large foamed core material to be needed and, thereby, eliminating the requirement that a large furnace be used to manufacture the foam glass, reducing the breakage of foam glass typically associated with manufacturing large sheets of foam core materials, and allowing the fabrication of panels to be quickly joined to form a finished building product at the construction site.

In particular, FIG. 24 shows an example of a larger single-core panel constructed by stacking rigid foam core material components 100, 101, 102 (in a brick like, alternating course fashion) and protective layers 105, 106, 107, 108 having smaller dimensions, in accordance with an embodiment of the present invention. The structured netting or membrane 110, 111 spans the entire assembly unbroken—it distributes any internal and external shear forces evenly across all components of the assembly 115, thereby allowing the smaller dimensioned parts to act as a whole. FIG. 25 shows an example of a larger multiple-core panel constructed by stacking rigid foam material components 100, 101, 102, 120, 121, 122, 123, 130, 131, 132 (in a brick like, alternating course fashion, such that, for example, joints between the components 100, 101, 102 do not align with the joints between components 120, 121, 122, 123 in the next sequential stack, and similarly for each sequentially proceeding and following stack, for each stack) and protective layers 105, 106, 107, 108 having smaller dimensions, in accordance with an embodiment of the present invention. The structured netting or membrane 110, 111, 140, 141 spans the entire assembly 155 unbroken—it distributes any internal and external shear forces evenly across all components of the assembly thereby allowing the smaller dimensioned parts to act as a whole.

In some specific applications and situations or to make larger panels, a series of rigid foamed core material can be stacked in other fashions to improve the overall structural performance of the assembly.

In accordance with embodiments of the present invention, it is also noted that, since the reinforcing membrane or netting distributes most of the shear force of the assembly; the protective layer(s) can be made of a smaller size than that of the finished panel. This eliminates the need for materials such as jumbo engineered planar panels (including, but not limited to plywood, oriented strand board, gypsum board, etc) and reduces the cost of the panel.

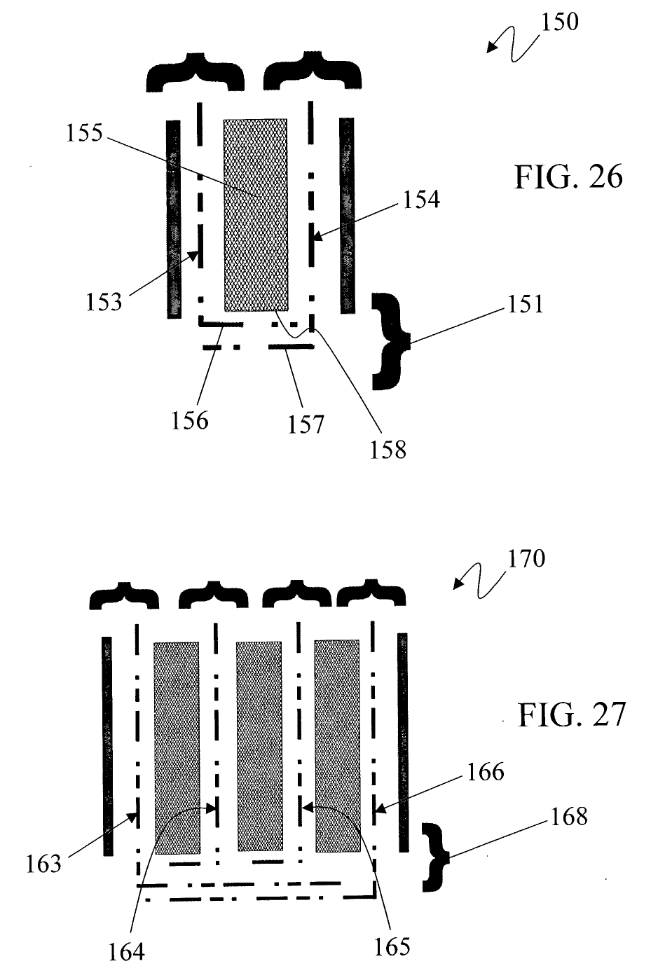

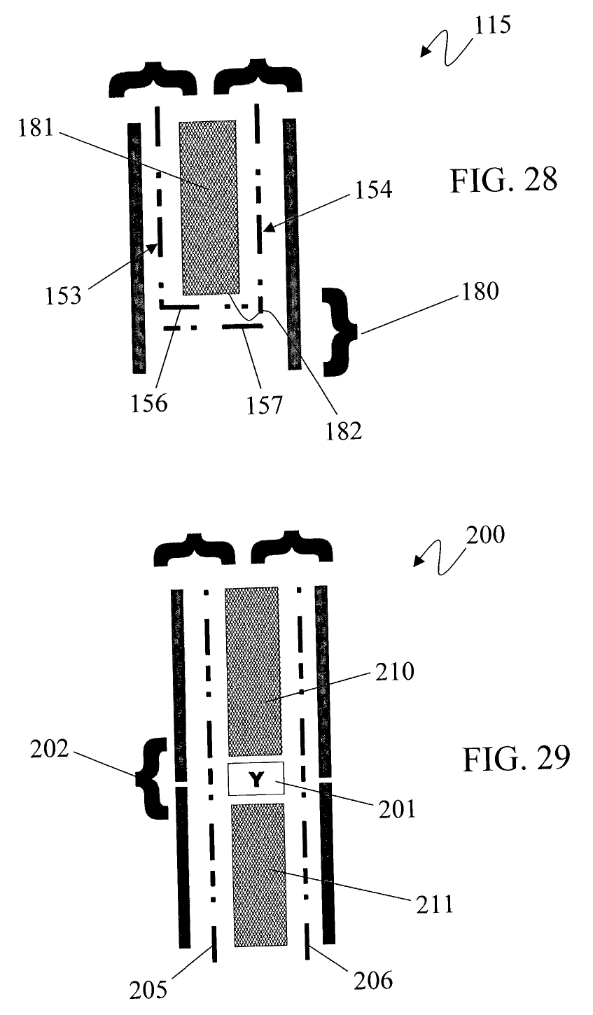

As is shown in FIGS. 26-28, it is also possible to form the edge of the assembly so that the structural reinforcing membranes or netting overlap the edge of the rigid foamed core material to protect against accidental damage and abrasion. Excess netting or membranes can extend past the edge of the rigid foamed core material and can be lapped over and fastened either by mechanical or chemical fixing to another part of the panel. In embodiments in which the assembly has multiple layers, each layer of netting may be lapped over about the core material, as shown, for example, in FIGS. 26 and 27, left in place to provide padding, or cut to dimension, as shown, for example, in FIG. 28.

In particular, FIG. 26 shows the wrapping of the structural reinforcing membrane 153, 154 around the panel edge 158 for a single-core panel 150, in accordance with an embodiment of the present invention. FIG. 27 shows the wrapping of the structural reinforcing membrane 163, 164, 165, 166 around the panel edge 168 for a multiple-core panel 120, in accordance with an embodiment of the present invention. In this embodiment, the interior membranes 163, 164, 165, 166 act as padding of cushioning to protect the edge 168 of the assembly 170. FIG. 28 shows the wrapping 180 of the structural reinforcing membrane 153, 154, 165, 166 around the panel edge 182 of the rigid foam core 181, cut to dimension, in accordance with an embodiment of the present invention.

Likewise, it is possible to embed other structural and nonstructural materials 201 within the assembly 200, as shown in FIG. 29. The joint between two assemblies 202 can be either fastened mechanically or chemically. It is important, in this embodiment, for example, that the netting or other membrane 205, 206 be continuous and able to bind many different components together to make the whole of the structure 200, since that the netting or other membrane 205, 206 is responsible, in part, for distributing the shear forces of the entire assembly 200.

As shown in FIG. 29, material 201, not a rigid foam material, can be embedded within the panel 200, in accordance with an embodiment of the present invention. The embedded materials 201 could include, but are not limited to, structural members that enhance the overall performance of the assembly 200, or nonstructural that allow the panel to be connected to larger assemblies, to each other, or to other materials.

In many cases and situations, these assemblies outperform other cellular materials used in building products and offer value added options and opportunities to tailor the performance specifications of the entire assembly or each individual layer in the assembly, therefore making the assembly highly attractive as compared to other cellular based building assemblies (prior art).

Example embodiments of the present invention have now been described in accordance with the above advantages. It will be appreciated that these examples are merely illustrative of the invention. Many variations and modifications will be apparent to those skilled in the art.

What is claimed is:

1. A rigid, shear resistant, and impact resistant composite structure, the composite structure comprising:
a first protective layer forming a first side;
a rigid foamed core material fixably held relative to the first protective layer; and
a first structural reinforcing membrane attached to the rigid foamed core material.

2. The composite structure of claim 1, wherein the rigid foamed core material is sandwichably fixed between the first protective layer and the first structural reinforcing membrane.

3. The composite structure of claim 1, wherein the first structural reinforcing membrane is sandwichably fixed between the rigid foamed core material and the first protective layer.

4. The composite structure of claim 3, further comprising:
a second structural reinforcing membrane sandwichably fixed between the rigid foamed core material and the first protective layer.

5. The composite structure of claim 1, further comprising:
a second protective layer forming a second side.

6. The composite structure of claim 3, wherein the first protective layer is attached to the structural reinforcing membrane.

7. The composite structure of claim 6, wherein the structural reinforcing membrane is attached to the rigid foamed core material.

8. The composite structure of claim 5, further comprising:
a second structural reinforcing membrane sandwichably located between the second protective layer and the rigid foamed core material.

9. The composite structure of claim 8, further comprising:
a third structural reinforcing membrane sandwichably located between the first structural reinforcing membrane and the rigid foamed core material.

10. The composite structure of claim 6, wherein the first and second protective layers each have a generally planar surface, the first protective layer planar surface being approximately parallel to the second protective layer planar surface.

11. The composite structure of claim 6, wherein the first protective layer is attached to the structural reinforcing membrane via chemical bonding.

12. The composite structure of claim 6, wherein the first protective layer is attached to the structural reinforcing membrane via mechanical bonding.

13. The composite structure of claim 1, wherein the first protective layer is an exterior protective layer.

14. The composite structure of claim 1, wherein the rigid foamed core material comprises foam glass.

15. The composite structure of claim 11, wherein the foam glass comprises waste glass.

16. The composite structure of claim 1, wherein the rigid foamed core material is porous.

17. The composite structure of claim 1, wherein the rigid foamed core material comprises foamed fly-ash.

18. The composite structure of claim 1, wherein the rigid foamed core material comprises recycled material.

19. The composite structure of claim 1, wherein the composite structure comprises organic material.

20. The composite structure of claim 1, wherein the composite structure is formed as a panel.

21. The composite structure of claim 1, wherein the composite structure is usable as a building material.

22. The composite structure of claim 21, wherein the building material is selected from a group consisting of a structural panel, a structural insulated panel, exterior sheathing, interior sheathing, backing board, floor tile, ceiling tile, a floor assembly, a wall assembly, a roof assembly, an exterior tile, an interior tile, structural insulation, an exterior insulation and finishing system, a rigid insulation product, a replacement for a blown insulation product, a countertop, a laminate, a structural member, a board, a low density structural material, and a rigid floatable assembly.

23. The composite structure of claim 1, wherein the composite structure is usable as a packaging material.

24. The composite structure of claim 1, wherein the composite structure comprises a fire resistant material.

25. The composite structure of claim 1, wherein the composite structure comprises a blast resistant material.

26. The composite structure of claim 1, wherein the composite structure comprises a projectile resistant material.

27. The composite structure of claim 1, wherein the composite structure comprises a breathable material.

28. The composite structure of claim 1, wherein the composite structure comprises a moisture impervious material.

29. The composite structure of claim 1, wherein the first structural reinforcing membrane comprises a netting.

30. The composite structure of claim 1, wherein the first structural reinforcing membrane comprises a webbing.

31. The composite structure of claim 1, wherein the first-structural reinforcing membrane comprises a mesh.

32. The composite structure of claim 1, wherein the first structural reinforcing membrane comprises an organic material.

33. The composite structure of claim 32, wherein the organic material is selected from a group consisting of paper and wood.

34. The composite structure of claim 1, wherein the first structural reinforcing membrane comprises an inorganic material.

35. The composite structure of claim 34, wherein the inorganic material is selected from a group consisting of metal, plastic, fiberglass, nylon, ballistic nylon, and glass.

36. The composite structure of claim 1, wherein the first protective layer comprises a polyurethane film.

37. The composite structure of claim 5, further comprising:
a second rigid foamed core material sandwichably located between the rigid foamed core material and the second protective planar layer; and
a fifth structural reinforcing membrane sandwichably located between the rigid foamed core material and the second rigid foamed core material.

38. The composite structure of claim 1, wherein the rigid foamed core material has a first end, and wherein the first structural reinforcing membrane is wrapped about the first end of the rigid foamed core material.

39. The composite structure of claim 4, wherein the rigid foamed core material has a first end, and wherein the first structural reinforcing membrane is wrapped about the first end of the rigid foamed core material, and wherein the second structural reinforcing membrane is wrapped about the first end of the rigid foamed core material.

40. The composite structure of claim 1, wherein the rigid foamed core material includes a plurality of foamed core material components abuttably forming a stack.

41. The composite structure of claim 37, wherein the rigid foamed core material includes a first plurality of foamed core material components abuttably formed in a first stack, and wherein the second rigid foamed core material includes a plurality of foamed core material components abuttably formed in a second stack.

42. The composite structure of claim 41, wherein the first stack includes a first plurality of joints between abutting foamed core material components, and wherein the second stack includes a second plurality of joints between abutting foamed core material components.

43. The composite structure of claim 42, wherein first plurality of joints are not aligned with the second plurality of joints.

44. The composite structure of claim 1, wherein the first protective layer includes a first plurality of protective layer components abuttably forming a first protective layer stack.

45. The composite structure of claim 40, wherein the first protective layer includes a first plurality of protective layer components abuttably forming a first protective layer stack, wherein the first protective layer stack includes a plurality of joints between abutting protective layer components, and wherein the foamed core material stack includes a plurality of joints between abutting foamed core material components.

46. The composite structure of claim 45, wherein the plurality of joints between abutting protective layer components are not aligned with the plurality of joints between abutting foamed core material components.

47. A composite structure, comprising:
at least one of protective layer; and
a sandwiched structure attached to each of the at least one protective layer;
wherein the interior structure comprises at least a pair of parallel layers of structural reinforcing membrane and a rigid foamed core material layer.

48. The composite structure of claim 47, wherein the sandwiched structure comprises a plurality of parallel layers of structural reinforcing membrane and a plurality of rigid foamed core material layers, wherein each of the rigid foamed core material layers is sandwiched between a pair of the plurality of parallel layers of structural reinforcing membrane.

49. The composite structure of claim 47, wherein each of the rigid foamed core material layers includes a plurality of foamed core material components abuttably formed in a stack.

50. The composite structure of claim 49, wherein each stack includes a plurality of joints between abutting foamed core material components, and wherein no two sequential stacks include aligned joints.

51. The composite structure of claim 47, wherein the interior structure comprises:
alternating layers of structural reinforcing membrane and rigid foamed core material.

52. The composite structure of claim 47, wherein the interior structure comprises:
a first pair of layers of structural reinforcing membrane;
a first rigid foamed core material layer abutting the first pair of layers of structural reinforcing membrane;
a single layer of structural reinforcing membrane abutting the first rigid foamed core material layer;
a second rigid foamed core material layer abutting the single layer of structural reinforcing membrane; and
a second pair of layers of structural reinforcing membrane abutting the second rigid foamed core material layer.

53. A composite structure having a first planar surface and a second planar surface opposite the first planar surface, the composite structure comprising:
a first protective layer;
a first structural reinforcing membrane attached to the first protective layer;
a rigid foamed core material attached to the first structural reinforcing membrane; and
a second structural reinforcing membrane attached to the rigid foamed core material

54. The composite structure of claim 53, further comprising:
a second protective surface attached to the second structural reinforcing membrane.

55. A composite structure having a first planar surface and a second planar surface opposite the first planar surface, the composite structure comprising:
a first protective layer;
a first structural reinforcing membrane attached to the first protective layer;
a second structural reinforcing membrane attached to the first structural reinforcing membrane;
a rigid foamed core material attached to the second structural reinforcing membrane;
a third structural reinforcing membrane attached to the rigid foamed core material;
a fourth structural reinforcing membrane attached to the third structural reinforcing membrane; and
a second protective surface attached to the fourth structural reinforcing membrane.
